(19) United States
(12) Patent Application Publication
(10) Pub. No.: US 2024/0177361 A1
(43) Pub. Date: May 30, 2024

(54) HUMAN TO AVATAR TRANSFORMATION

(71) Applicant: Intuit Inc., Mountain View, CA (US)

(72) Inventors: Jacquelyn Porter, San Diego, CA (US); David Dominick Demarro, San Diego, CA (US); Chloe Kai Walecki, Mountain View, CA (US); Lynda Beth Nario, San Diego, CA (US)

(73) Assignee: Intuit Inc., Mountain View, CA (US)

(21) Appl. No.: 18/072,649

(22) Filed: Nov. 30, 2022

(51) Int. Cl. G06T 11/00; G06Q 40/12

(52) U.S. Cl. CPC G06T 11/00; G06Q 40/12

(57) ABSTRACT

A method, computer program product, and system are provided. A request to initiate a virtual environment for a first user is received from a first application via a network connection with a first user device, a request. The first user is represented by a first avatar within the virtual environment. Based on the request, session data of the first application for the first user is identified. A second user is selected based on the session data. The second user is represented by a second avatar within the virtual environment. Via the network connection, a video is displayed to the first user, transforming a real-world image of the second user into the second avatar. The virtual environment is launched on the user device of the first user, and the first avatar and the second avatar are assigned to adjacent locations within the virtual environment. The virtual environment is rendered with the first avatar and the second avatar at the adjacent locations, The virtual environment is displayed to the first user via the network connection.

### BACKGROUND

Virtual environments are being used to simulate real life environments that enable online entertainment, education, training, shopping, and other types of interactions between disparate users. A virtual environment is typically a multi-dimensional computer simulated environment that is used to facilitate interaction between two or more users. In operation, each user runs a virtual environment client on a computing device that communicates with a virtual environment server over a computer network, such as a local area network or wide area network.

Interaction between users in the virtual environment is facilitated by avatars, which are digital characters representing the users. Each user in the virtual environment has their own avatar and may customize its appearance. Movements and interaction of an avatar in the virtual environment is controlled by the corresponding user by using a combination of input/output devices such as a computer mouse, keyboard, audio headset and microphone.

Because avatars are digital abstractions of the users, avatars provide a degree of user anonymity into the virtual environment. While this virtual disconnect may be perfectly acceptable in certain entertainment environments, it can be harmful in a business setting where a trusted relationship between users is paramount. Furthermore, with the advancement of chatbot systems for providing online services, users often find it increasingly difficult to distinguish authentic interactions with trusted users from automated or impersonated identities. Users in a virtual environment may be reluctant to share personal information or engage in real-world transactions when the identity of other users cannot be trusted.

Distrust of the user can be exacerbated by the avatar itself. For example, in aesthetics, the uncanny valley is a hypothesized relation between an object's degree of resemblance to a human being and the emotional response to the object. With the increasing prevalence of virtual reality, augmented reality, and photorealistic computer animation, the “valley” has been cited in reaction to the verisimilitude of the creation as it approaches indistinguishability from reality.

### SUMMARY

In general, in one aspect, one or more embodiments related to a method. The method includes receiving from a first application via a network connection with a first user device, a request to initiate a virtual environment for a first user. The first user is represented by a first avatar within the virtual environment. The method further includes, based on the request, identifying session data of the first application for the first user. The method additionally includes selecting a second user based on the session data. The second user is represented by a second avatar within the virtual environment. The method also includes displaying, to the first user via the network connection, a video transforming a real-world image of the second user into the second avatar. The method further includes launching the virtual environment on the user device of the first user. The method also includes assigning the first avatar and the second avatar to adjacent locations within the virtual environment. The method additionally includes rendering the virtual environment with the first avatar and the second avatar at the adjacent locations. The method also includes displaying the virtual environment to the first user via the network connection.

In general, in one aspect, one or more embodiments related to a computer program product comprising non-transitory computer-readable program code that, when executed by a computer processor of a computing system, cause the computing system to perform operations. The operations include receiving from a first application via a network connection with a first user device, a request to initiate a virtual environment for a first user. The first user is represented by a first avatar within the virtual environment. The operations further include, based on the request, identifying session data of the first application for the first user. The operations additionally include selecting a second user based on the session data. The second user is represented by a second avatar within the virtual environment. The operations also include displaying, to the first user via the network connection, a video transforming a real-world image of the second user into the second avatar. The operations further include launching the virtual environment on the user device of the first user. The operations also include assigning the first avatar and the second avatar to adjacent locations within the virtual environment. The operations additionally include rendering the virtual environment with the first avatar and the second avatar at the adjacent locations. The operations also include displaying the virtual environment to the first user via the network connection.

In general, in one aspect, one or more embodiments related to a system comprising a computer processor, a memory, and instructions stored in the memory. The instructions are executable by the computer processor to cause the computer processor to perform operations. The operations include receiving from a first application via a network connection with a first user device, a request to initiate a virtual environment for a first user. The first user is represented by a first avatar within the virtual environment. The operations further include, based on the request, identifying session data of the first application for the first user. The operations additionally include selecting a second user based on the session data. The second user is represented by a second avatar within the virtual environment. The operations also include displaying, to the first user via the network connection, a video transforming a real-world image of the second user into the second avatar. The operations further include launching the virtual environment on the user device of the first user. The operations also include assigning the first avatar and the second avatar to adjacent locations within the virtual environment. The operations additionally include rendering the virtual environment with the first avatar and the second avatar at the adjacent locations. The operations also include displaying the virtual environment to the first user via the network connection.

Other aspects of the invention will be apparent from the following description and the appended claims.

### BRIEF DESCRIPTION OF DRAWINGS

FIG. 1 illustrates an example data processing environment (“environment”) (100) in accordance with the disclosed embodiments.

FIG. 2 shows a virtual environment, in accordance with one or more embodiments.

FIG. 3 is a schematic representation of a video, shown in accordance with one or more embodiments.

FIG. 4 shows a flow chart of a process 400, in accordance with one or more embodiments.

FIG. 5 shows a first example of a video in accordance with one or more embodiments.

FIG. 6 shows a second example of a video in accordance with one or more embodiments.

FIG. 7 shows a computing system in accordance with one or more embodiments of the invention.

Like elements in the various figures are denoted by like reference numerals for consistency.

### DETAILED DESCRIPTION

In general, embodiments are directed to methods for maintaining user confidence in a live subject matter expert when interacting in a virtual environment. Live experts are the primary drivers of consumer confidence in users of software services. However, consumers maybe more comfortable interacting with an avatar in an online virtual experience. Embodiments described herein ensure that live customer trust does not erode upon entering into an avatar-to-avatar interaction with a live expert in an online virtual environment.

Embodiments of the present invention are directed to a design interaction pattern where a video is displayed as an introduction to interactions within the virtual world. A real-world image of the tax expert is shown transforming into their avatar form to ensure consumer confidence in the expert does not erode upon entering the virtual environment. The interaction can occur in a virtual environment lobby, or inside a virtual object within the virtual environment, such as a business office space.

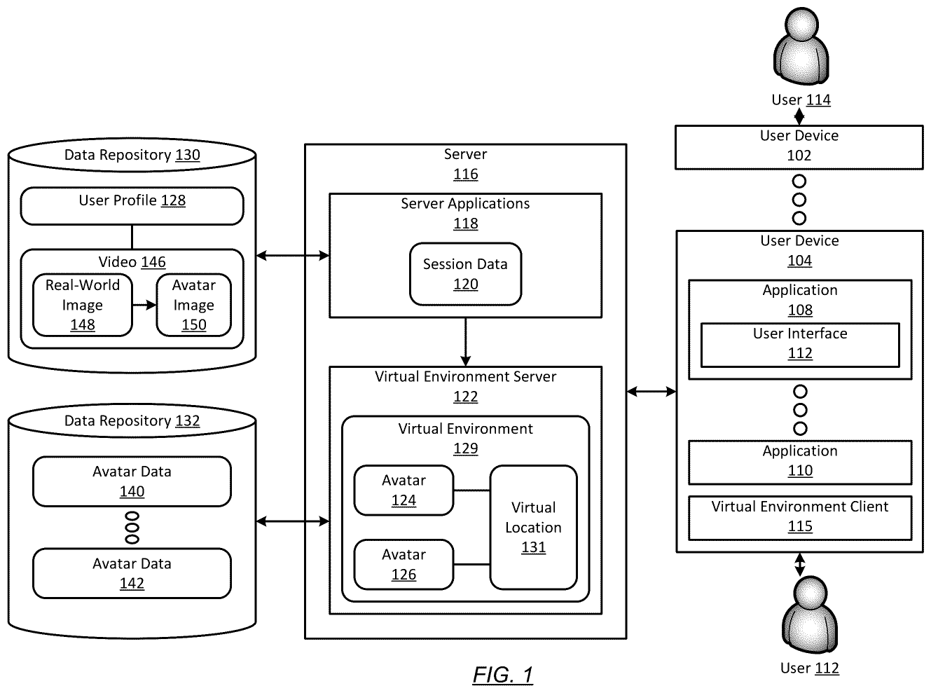

Turning now to the figures, FIG. 1 illustrates an example data processing environment (“environment”) (100) in accordance with the disclosed embodiments. In some embodiments, the environment (100) can one or more client devices (102, 104), one or more server (106), and one or more data repositories (130, 132), communicatively coupled to one another by way of network. The client device (102, 104) may be used or otherwise accessed by one or more users (112, 114).

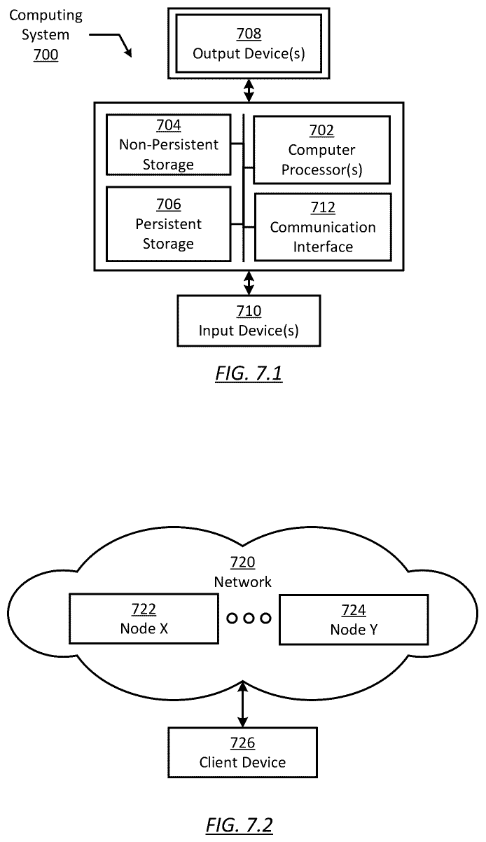

The client devices (102, 104) can be any variety of electronic devices capable of consuming, providing, and/or rendering data communicated across a network. For example, the client devices (102, 104) can include one or more computer systems similar to that of the computer system (700) described below with regard to at least FIG. 7.

Client devices (102, 104) can include one or more applications that can be used to request content, to provide content, to render content, and/or to send and/or receive requests to and/or from other devices via the network. For example, a client device (102) may include an Internet browser application, a web services application, or a web conferencing client application. These applications may facilitate communication with server (106), server applications (118) running on the server (106), and/or other client devices.

The server (106) is a computing system in accordance with those described in FIGS. 7.1 and 7.2, and, in one or more embodiments, may be any type of endpoint to be reached by the devices (102, 104). For example, the server (106) may host server applications (118) such as webpages, applications, or streaming content that are accessible using the client devices (102, 104).

Server applications (118) can include session data (120). Session Data is server-side metadata associated with the running of client applications (108). Session data can include usage information for client devices (102, 104) and the users thereof, such as IP Address, type of browser, type of operating system, referring URL, date, time, and duration of a visitor's visit, the number of visits to a website, the pages viewed, order of pages viewed, number of cookies accumulated, bytes sent and received, user agent, URI stem, URI query, or MAC address. Session data (120) for a user (112) can include identifiers of one or more different users, e.g., user (114). The identifier may uniquely identify a user profile (128) of the user (114), discussed below.

The virtual environment server (122) is a computing system in accordance with those described in FIGS. 7.1 and 7.2. The virtual environment server (122) may host an application that provides a simulated virtual environment in which users (112, 114) can interact. This virtual environment (129) can be a, for example, a virtual reality “metaverse,” characterized by persistent virtual worlds that continue to exist even when a user is offline, as well as an augmented reality that combines aspects of the digital and physical worlds. Client devices (102, 104,) may include a virtual environment client (115) that can be used to interact with the virtual environment server (122).

Avatars (124, 126) represent users (112, 114) in the virtual environment of virtual environment server (122). Avatars (124, 126) are spatially distributed in the virtual environment, with their virtual locations being expressed as a set of coordinates in the virtual environment. A location of an avatar or other objects in the virtual environment may be expressed as a set of coordinates in a cartesian coordinate system (e.g., x,y,z), geographic coordinate system (e.g., latitude, longitude), or other coordinate system that is utilized by the virtual environment. For example, avatars (124, 126) placed at a virtual location (131) in the virtual environment may be identified by the (x,y,z) coordinates, as well as other information related to the virtual environment, such as a landmark, a building, a city, a country, or a region.

The server (116) may connect to one or more data repositories (130, 132). In one or more embodiments of the invention, the data repositories (130, 132) are any type of storage unit and/or device (e.g., a file system, database, data structure, or any other storage mechanism) for storing data. Further, the data repositories (130, 132) may include multiple different, potentially heterogeneous, storage units and/or devices.

The data repository (132) stores avatar data (140, 142) for the avatars (124, 126). The avatar data (140,142) is data used by virtual environment server (122) and/or virtual environment client (115) to generate the avatars (124, 126). For example, avatar data (140, 142) may include one or more variables values assigned to these variables may represent different physical characteristics of avatars (124, 126), such as hairstyles, outfits, skin tones, gender, and facial features, etc. Avatar data (140, 142) may be a unique or semi unique combination of variables, such the avatars of different users can have different appearances within the virtual environment (129).

Data repository (130) is a storage repository for storing user profiles for the users (112, 114) of server applications (118). User profiles (144) are data about users (112, 114), and may be identified by respective unique identifiers. The User profiles (128) may include additional identity data for a user, such as, a user's name, address, date of birth, social security numbers, as well as other customer-related data such as rules and permissions for using the software application, etc.

In one or more embodiments, a user profile (128) can be uniquely associated with a video (146). The video (146) is a sequence that transitions from a real-world image of a user to an image of the user's avatar. For example, video (146) transitions from a real-world image (148) of user (112) to an avatar image (150) of the avatar (124) of the user (112). In an example, the real-world image (148) can be loaded from storage, or captured from a video feed from an imaging device such as a video camera. The video (146) can be pre generated, or can be generated dynamically based upon a video template whereby images are injected at key placeholders in a predefined series, e.g., image→transition→image→closing.

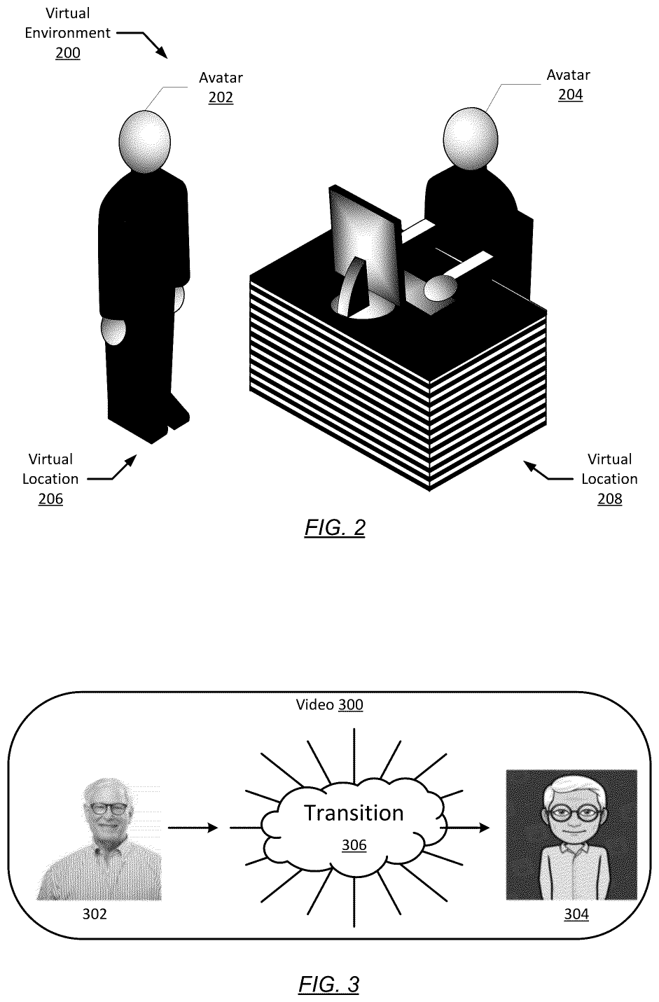

Referring now to FIG. 2, a virtual environment is shown according to illustrative embodiments. The virtual environment 200 of FIG. 2 is an example of the virtual environment (129) of FIG. 1.

The avatar (202) and avatar (204) are avatars of a first user and a second user, respectively. The avatar (202) is rendered in the virtual environment (200) at a virtual location (206). The avatar (204) is rendered at virtual location (208). The virtual locations (206, 208) are adjacent locations within the virtual environment (200). As used herein, locations within the virtual environment are “adjacent” when the distance between the locations meets a threshold distance. The distance can be defined in terms of a coordinate system That is utilized by the virtual environment (200). For example, the distance between objects in the virtual environment may be defined as:

d=\sqrt{(x₂−x₁)²+(y₂−y₁)²+(z₂−z₁)²}

### Wherein:

(x₁, y₁, z₁) are the XYZ coordinates of a first location; and
(x₂, y₂, z₂) are the XYZ coordinates of a second location.

Alternatively, a common location may be defined as a delineated area within the virtual environment associated with a virtual object of defined dimensions. Two locations may be considered “adjacent” when they are both within the delineated bounds of the virtual object. For example, the virtual locations (206, 208) that are within the XYZ dimensions defined for an “office space,” may be considered as adjacent locations within the virtual environment (200).

Referring now to FIG. 3, a schematic representation of a video is shown according to illustrative embodiments. The video (300) is an example of video (146) of FIG. 1.

The video (300) is unique to its respective user, and can be associated with a respective user profile or unique identifier of the user. For example, the video (300) may be associated with the user (112) of FIG. 1. The video (300) transitions from a user's real-world image (302) to an avatar image (304) of the user within a virtual environment.

The video combines the images (302, 304) in sequence, with transitions (306), over a certain period of time. The images and transitions can be selected to impart a desired purposes and tone to the video (300).

In some embodiments, the video is dynamically created through a predefined series of video creation steps (e.g., image→transition→image→closing). For example, using one such pre-defined template, the renderer would inject the image at the appropriate placeholder. A number of transitions (fade, dissolve, ken-burns, etc.) can be identified that are appropriate for the images and applied as such. The transitions can be selected based upon the theme or tone of the video. The transitions may be quick cuts for up-tempo, or slow dissolves for more low-key video.

While FIG. 1-FIG. 3 show a configuration of components, other configurations may be used without departing from the scope of the invention. For example, various components may be combined to create a single component. As another example, the functionality performed by a single component may be performed by two or more components.

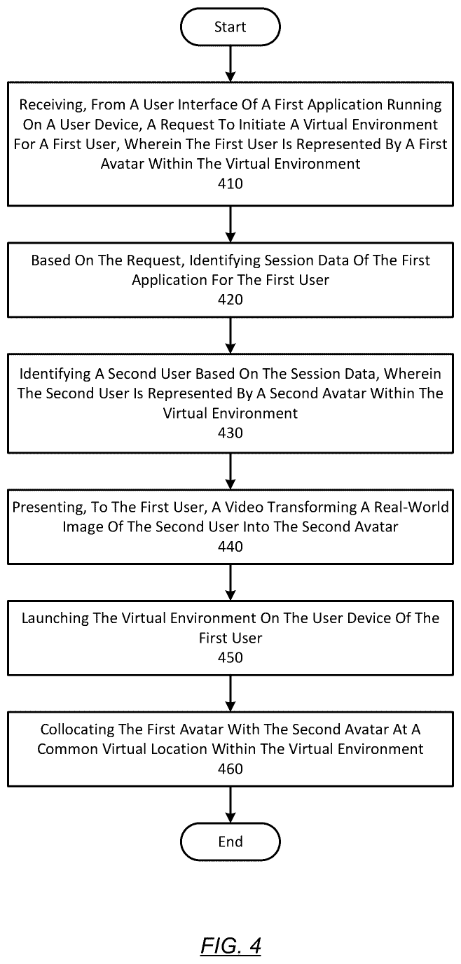

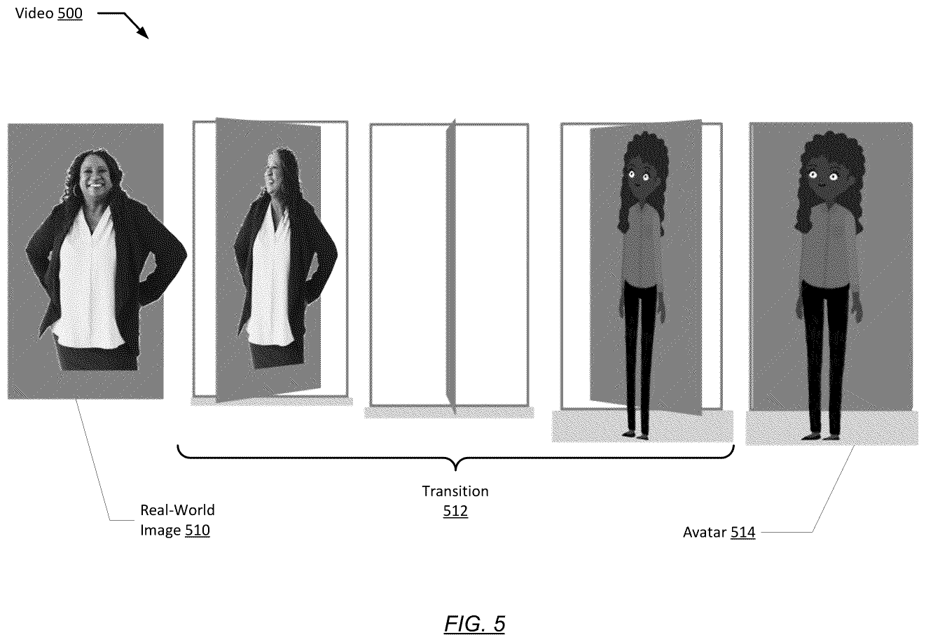

FIG. 4 shows a flowchart of the process for displaying a virtual environment in accordance with the disclosure. The process 400 can be performed using one or more components illustrated in FIG. 1. FIG. 5 provides a general overview of one or more embodiments.

While the various steps in this flowchart are presented and described sequentially, at least some of the steps may be executed in different orders, may be combined or omitted, and at least some of the steps may be executed in parallel. Furthermore, the steps may be performed actively or passively.

At block 410, a request to initiate a virtual environment is received for a first user. The request can be received from a first application via a network connection with a first user device.

In one or more embodiments, the first application may be selected from an accounting application and a bookkeeping application. For example, the first applications might include accounting/bookkeeping applications such as Quickbooksonline™, Mint, and TurboTax®. In one or more embodiments, the first applications might be massively multi-user (e.g., have thousands or millions of users) and may include both professional and/or non-professional users.

The first user is represented by a first avatar within the virtual environment. In an example, the virtual environment is separate from the first application. In other words, the virtual environment may not be provided as a service of the first application.

At block 420, based on the request, session data of the first application is identified for the first user. The session data can be session data (120) of FIG. 1.

At block 420, a second user is selected based on the session data. The second user is represented by a second avatar within the virtual environment.

The second user can be selected in a number of different ways. For example, when the first user and the second user are engaged in a live interaction, such as a chat or video conference, a unique identifier of the second user may be indicated in the session data. According to the embodiment, the method may include identifying a unique identifier in the session data, wherein the unique identifier is associated with a user profile of the second user. The user profile of the second user includes a video that is unique to the second user.

In another example, this session data may indicate a user profile of the first user. The second user may be identified within the first user's profile, as an assigned professional, service provider, account manager, etc. The user profile of the second user includes a video that is unique to the second user. According to the embodiment, the method may include identifying a first unique identifier in the session data, wherein the first unique identifier is associated with a first user profile of the first user. A second unique identifier is identified from the first user profile, wherein the second unique identifier is associated with a second user profile of the second user.

At block 430, the video is displayed to the first user via the network connection. Beginning with a real-world image of the second user, the video transitions to the second avatar.

In an example, the video can be pre-generated from stored images of the second user and the second avatar. The video is selected from storage based on a unique identifier associated with the second user, and sent to the first user device for display.

In an example, the video can be dynamically generated in real time or near real time. For example, the real-world image of the second user can be captured from a video feed from an imaging device such as a video camera. The real-world image is injected at a key placeholder in a video template; and the video is dynamically generated from the video template.

In an example, the second avatar can be dynamically generated from avatar data for the second avatar. The avatar data is selected based on the unique identifier associated with the second user, and the second avatar is generated from the second avatar data. The second avatar is injected at a key placeholder in a video template; and the video is dynamically generated from the video template.

By viewing the video, the first user is able to see the second user transforming into their respective avatar. Thus, the video provides a measure of assurance as to the real-world identity of the second avatar within the virtual environment.

At block 440, the virtual environment is launched on the user device of the first user. In one example, the virtual environment is launched after completion of the video. In another example, the virtual environment is launched upon receipt of the request, and runs in the background until the video has finished playing.

At block 450, the first avatar and the second avatar are assigned to adjacent locations within the virtual environment.

At block 460, the virtual environment is rendered with the first avatar and the second avatar at the adjacent locations.

At block 470, the virtual environment is displayed to the first user via the network connection.

Referring now to FIG. 5, a first example of video composition is shown in accordance with one or more embodiments of the invention. In the following example, consider the scenario where a customer using online application services has requested live help from an account professional. Based on the request, a video unique to the account professional is selected and played to the customer prior to entering a help session within a virtual environment.

The video (500) begins by displaying a real-world image (510) of the account professional. The real-world image (510) undergoes a transition (512) into the avatar (514) of the account professional. The transition (512) is an example of a “3D Flip” or “revolving door” transition. The transition (512) can be selected by the account professional based on a desired sentiment for the video (500). Alternatively, the transition (512) can be preconfigured as part of a video template.

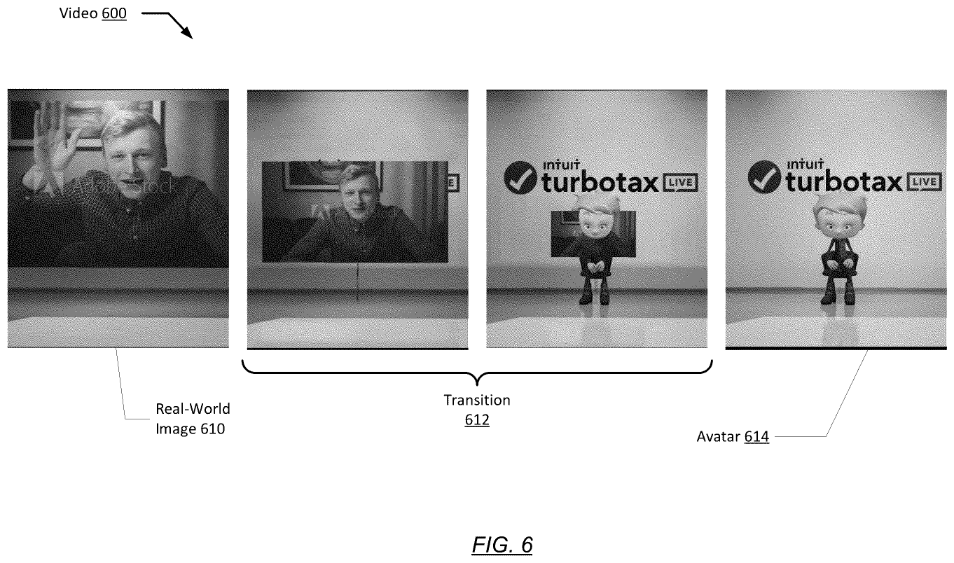

Referring now to FIG. 6, a first example of video composition is shown in accordance with one or more embodiments of the invention. In the following example, consider the scenario where the customer Using online application services has requested live help from an account professional. Based on the request, a video unique to the account professional is selected and played to the customer prior to entering a virtual environment.

The video (600) begins by displaying a real-world image (610) of the account professional. The real-world image (610) undergoes a transition (612) into the avatar (614) of the account professional. The transition (612) is an example of a “zoom-in/zoom-out” transition. The transition (612) can be selected by the account professional based on a desired Sentiment for the video (600).

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 7.1, the computing system (700) may include one or more computer processors (702), non-persistent storage (704), persistent storage (706), a communication interface (712) (e.g., Bluetooth interface, infrared interface, network interface, optical interface, etc.), and numerous other elements and functionalities that implement the features and elements of the disclosure. The computer processor(s) (702) may be an integrated circuit for processing instructions. For example, the computer processor(s) may be one or more cores or micro-cores of a processor. The input devices (710) may include a touchscreen, keyboard, mouse, microphone, touchpad, electronic pen, or any other type of input device. The communication interface (712) may include an integrated circuit for connecting the computing system (700) to a network (not shown) (e.g., a local area network (LAN), a wide area network (WAN) such as the Internet, mobile network, or any other type of network) and/or to another device, such as another computing device.

Further, the output devices (708) may include a display device, a printer, external storage, or any other output device. One or more of the output devices may be the same or different from the input device(s). The input and output device(s) may be locally or remotely connected to the computer processor(s) (702). Many different types of computing systems exist, and the aforementioned input and output device(s) may take other forms.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

The computing system (700) in FIG. 7.1 may be connected to or be a part of a network. For example, as shown in FIG. 7.2, the network (720) may include multiple nodes (e.g., node X (722), node Y (724)). Each node may correspond to a computing system, such as the computing system shown in FIG. 7.1, or a group of nodes combined may correspond to the computing system shown in FIG. 7.1. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (700) may be located at a remote location and connected to the other elements over a network.

The nodes (e.g., node X (722), node Y (724)) in the network (720) may be configured to provide services for a client device (726), including receiving requests and transmitting responses to the client device (726). For example, the nodes may be part of a cloud computing system. The client device (726) may be a computing system, such as the computing system shown in FIG. 7.1. Further, the client device (726) may include and/or perform all or a portion of one or more embodiments of the invention.

The computing system of FIG. 7.1 may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an or may include any combination of the items with any number of each item unless expressly stated otherwise.

In the above description, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. Further, other embodiments not explicitly described above can be devised which do not depart from the scope of the invention as disclosed herein. Accordingly, the scope of the invention should be limited only by the attached claims.

1. A method comprising:
receiving, from a first application via a network connection with a first user device, a request to initiate a virtual environment for a first user, wherein the first user is represented by a first avatar within the virtual environment;
based on the request, identifying session data of the first application for the first user;
selecting a second user based on the session data, wherein the second user is represented by a second avatar within the virtual environment;
displaying, to the first user via the network connection, a video sequence of a real-world image of the second user transforming into the second avatar, wherein the video sequence comprises:
a first image of the real-world image,
a second image of the second avatar, and
a plurality of intermediate images each distorting at least one of the first image and the second image to show the real-world image transforming into the second avatar,
wherein the plurality of intermediate images is displayed in between the first image and the second image;
after completing the displaying of the video sequence, launching the virtual environment on the first user device of the first user; and
assigning the first avatar and the second avatar to adjacent locations within the virtual environment;
rendering the virtual environment with the first avatar and the second avatar at the adjacent locations; and
displaying the virtual environment to the first user via the network connection.

2. The method of claim 1, wherein the first application is selected from the group consisting of an accounting application and a bookkeeping application.

3. The method of claim 1, wherein selecting the second user further comprises:
identifying a unique identifier in the session data, wherein the unique identifier is associated with a user profile of the second user.

4. The method of claim 1, wherein selecting the second user further comprises:
identifying a first unique identifier in the session data, wherein the first unique identifier is associated with a first user profile of the first user; and
identifying a second unique identifier from the first user profile, wherein the second unique identifier is associated with a second user profile of the second user.

5. The method of claim 1, wherein displaying the video sequence further comprises:
selecting the video sequence based on a unique identifier associated with the second user, wherein the video sequence is a pre-generated video.

6. The method of claim 1, wherein displaying the video sequence further comprises:
capturing the real-world image from a video feed of the second user.

7. The method of claim 1, wherein displaying the video sequence further comprises:
selecting second avatar data for the second avatar based on a unique identifier associated with the second user;
generating the second avatar from the second avatar data;
injecting the second avatar at a key placeholder in a video template; and.
generating the video sequence from the video template.

8. A system comprising:
a computer processor;
memory; and
instructions stored in the memory and executable by the computer processor to cause the computer processor to perform operations, the operations comprising:
receiving, from a first application via a network connection with a first user device, a request to initiate a virtual environment for a first user, wherein the first user is represented by a first avatar within the virtual environment;
based on the request, identifying session data of the first application for the first user;
selecting a second user based on the session data, wherein the second user is represented by a second avatar within the virtual environment;
displaying, to the first user via the network connection, a video sequence of a real-world image of the second user transforming into the second avatar, wherein the video sequence comprises:
a first image of the real-world image,
a second image of the second avatar, and
a plurality of intermediate images each distorting at least one of the first image and the second image to show the real-world image transforming into the second avatar,
wherein the plurality of intermediate images is displayed in between the first image and the second image;
after completing the displaying of the video sequence, launching the virtual environment on the first user device of the first user; and
assigning the first avatar and the second avatar to adjacent locations within the virtual environment;
rendering the virtual environment with the first avatar and the second avatar at the adjacent locations; and
displaying the virtual environment to the first user via the network connection.

9. The system of claim 8, wherein the first application is selected from the group consisting of an accounting application and a bookkeeping application.

10. The system of claim 8, wherein selecting the second user further comprises:
identifying a unique identifier in the session data, wherein the unique identifier is associated with a user profile of the second user.

11. The system of claim 8, wherein selecting the second user further comprises:
identifying a first unique identifier in the session data, wherein the first unique identifier is associated with a first user profile of the first user; and
identifying a second unique identifier from the first user profile, wherein the second unique identifier is associated with a second user profile of the second user.

12. The system of claim 8, wherein displaying the video sequence further comprises:
selecting the video sequence based on a unique identifier associated with the second user, wherein the video sequence is a pre-generated video.

13. The system of claim 8, wherein displaying the video sequence further comprises:
capturing the real-world image from a video feed of the second user;
injecting the real-world image at a key placeholder in a video template; and
generating the video sequence from the video template.

14. The system of claim 8, wherein displaying the video sequence further comprises:
selecting second avatar data for the second avatar based on a unique identifier associated with the second user;
generating the second avatar from the second avatar data;
injecting the second avatar at a key placeholder in a video template; and.
generating the video sequence from the video template.

15. A computer program product comprising non-transitory computer-readable medium further comprising program code that, when executed by a computer processor of a computing system, causes the computing system to perform operations comprising:
receiving, from a first application via a network connection with a first user device, a request to initiate a virtual environment for a first user, wherein the first user is represented by a first avatar within the virtual environment;
based on the request, identifying session data of the first application for the first user;
selecting a second user based on the session data, wherein the second user is represented by a second avatar within the virtual environment;
displaying, to the first user via the network connection, a video sequence of a real-world image of the second user transforming into the second avatar, wherein the video sequence comprises:
a first image of the real-world image,
a second image of the second avatar, and
a plurality of intermediate images each distorting at least one of the first image and the second image to show the real-world image transforming into the second avatar,
wherein the plurality of intermediate images is displayed in between the first image and the second image;
after completing the displaying of the video sequence, launching the virtual environment on the first user device of the first user; and
assigning the first avatar and the second avatar to adjacent locations within the virtual environment;
rendering the virtual environment with the first avatar and the second avatar at the adjacent locations; and
displaying the virtual environment to the first user via the network connection.

16. The computer program product of claim 15, wherein selecting the second user further comprises:
identifying a unique identifier in the session data, wherein the unique identifier is associated with a user profile of the second user.

17. The computer program product of claim 15, wherein selecting the second user further comprises:
identifying a first unique identifier in the session data, wherein the first unique identifier is associated with a first user profile of the first user; and
identifying a second unique identifier from the first user profile, wherein the second unique identifier is associated with a second user profile of the second user.

18. The computer program product of claim 15, wherein displaying the video sequence further comprises:
selecting the video sequence based on a unique identifier associated with the second user, wherein the video sequence is a pre-generated video.

19. The computer program product of claim 15, wherein displaying the video sequence further comprises:
capturing the real-world image from a video feed of the second user;
injecting the real-world image at a key placeholder in a video template; and
generating the video sequence from the video template.

20. The computer program product of claim 15, wherein displaying the video sequence further comprises:
selecting second avatar data for the second avatar based on a unique identifier associated with the second user;
generating the second avatar from the second avatar data;
injecting the second avatar at a key placeholder in a video template; and.
generating the video sequence from the video template.
